(19) United States
(12) Patent Application Publication
(10) Pub. No.: US 2024/0004281 A1
(43) Pub. Date: Jan. 4, 2024

(54) VIRTUAL IMAGE DISPLAY DEVICE

(71) Applicant: SEIKO EPSON CORPORATION, Tokyo (JP)

(72) Inventor: Yoshihiro YOSHIMURA, Matsumoto-shi (JP)

(73) Assignee: SEIKO EPSON CORPORATION, Tokyo (JP)

(21) Appl. No.: 18/215,265

(22) Filed: Jun. 28, 2023

(30) Foreign Application Priority Data
Jun. 29, 2022 (JP) 2022-104319

(51) Int. Cl. G03B 21/28

(52) U.S. Cl. CPC G03B 21/28

(57) ABSTRACT

A virtual image display device includes an image forming unit, a projection optical system on which image light formed by the image forming unit is incident, and a reflection member configured to reflect the image light emitted from the projection optical system and project a virtual image, wherein at least a part of the projection optical system and the reflection member is an environment-conscious member formed of an environment-conscious material.

The present application is based on, and claims priority from JP Application Serial Number 2022-104319, filed Jun. 29, 2022, the disclosure of which is hereby incorporated by reference herein in its entirety.

### BACKGROUND

### 1. Technical Field

The present disclosure relates to a virtual image display device in which an environment-conscious material is employed.

### 2. Related Art

Disclosed is a virtual image display device including a video image element that emits video image light, a light-guiding member that guides the video image light, and a projection optical system that causes the video image light from the video image element to be incident on the light-guiding member (JP-A-2017-111363).

In a virtual image display device such as the one disclosed in JP-A-2017-111363, an optical member is preferably made of an environment-conscious material for reduction of carbon dioxide generated during thermal recycling. However, it is difficult to replace an optical material with an environment-conscious material because there is a problem in thermal resistance and disposal of an optical film and the like at the time of regeneration. In addition, since the characteristics required for an optical member constituting a virtual image display device are different from the characteristics of an environment-conscious material, it is difficult to simply replace the resin material with the environment-conscious material.

In addition, as the fields of using the virtual image display device, it is conceivable to operate a large number of the virtual image display devices in the fields of sightseeing and amusement, and it is desirable that an operator of the devices can easily check whether the luminance of the video reaches the end of the product life in order to guarantee the video quality.

### SUMMARY

A virtual image display device according to an aspect of the present disclosure includes an image forming unit, a projection optical system on which image light formed by the image forming unit is incident, and a reflection member configured to reflect the image light emitted from the projection optical system and project a virtual image, wherein at least a part of the projection optical system and the reflection member is an environment-conscious member formed of an environment-conscious material.

A virtual image display device according to an aspect of the present disclosure includes an image forming unit, a projection optical system on which image light formed by the image forming unit is incident, a reflection member configured to reflect the image light emitted from the projection optical system and project a virtual image, and a dimming member disposed on an optical path between the image forming unit and the virtual image, the dimming member having optical transparency and being configured to dim the image light, wherein the dimming member is formed of an environment-conscious material.

### BRIEF DESCRIPTION OF THE DRAWINGS

FIG. 1 is an external perspective view for describing a state of wearing a virtual image display device according to a first embodiment.

FIG. 2 is a side cross-sectional view for describing an internal structure of the virtual image display device.

FIG. 3 is a partially enlarged view for describing a reflection member of an optical system of the virtual image display device.

FIG. 4 is a block diagram for describing a circuit configuration of the virtual image display device.

FIG. 5 is a conceptual diagram for mainly describing a life management unit of the virtual image display device.

FIG. 6 is a conceptual diagram for describing a state in which a dimming member is changed in quality and clouded.

FIG. 7 is a cross-sectional view for describing an internal structure of a virtual image display device according to a second embodiment.

FIG. 8 is a partially enlarged view for describing a reflection member of an optical system of the virtual image display device illustrated in FIG. 7.

FIG. 9 is a side cross-sectional view for describing a virtual image display device according to a third embodiment.

### DESCRIPTION OF EXEMPLARY EMBODIMENTS

### First Embodiment

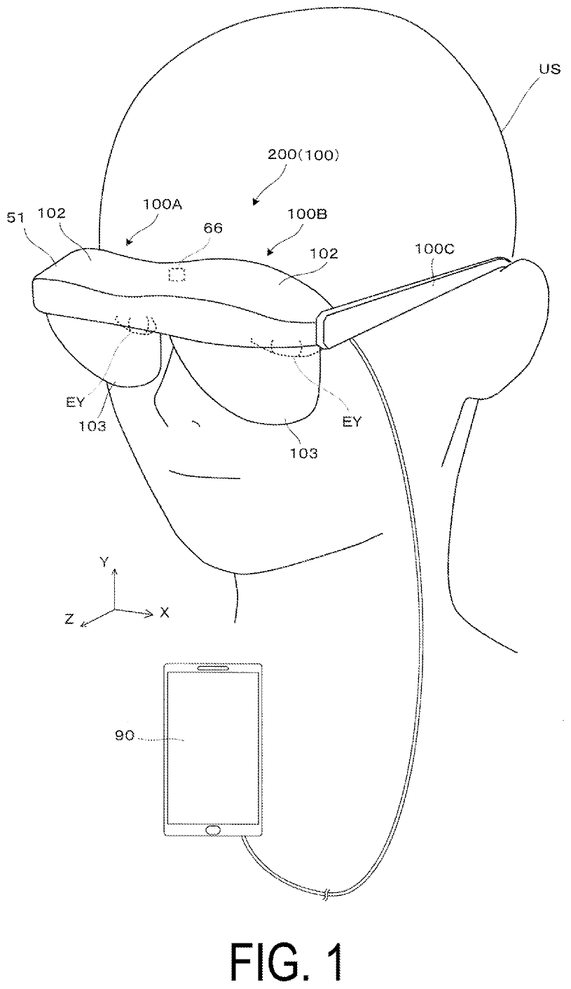

A virtual image display device according to a first embodiment of the present disclosure will be described below with reference to FIGS. 1 to 3.

FIG. 1 is a diagram for describing a state of wearing a head-mounted display (hereinafter also referred to as an HMD) 200. The HMD 200 allows an observer or wearer US who wears the HMD 200 to recognize an image as a virtual image. In FIG. 1 and the like, X, Y, and Z are orthogonal coordinates, the +X direction corresponds to a transverse direction in which both eyes EY of the observer or wearer US wearing the HMD 200 or a virtual image display device 100 are located side by side, the +Y direction corresponds to an upward direction orthogonal to the transverse direction in which both eyes EY of the wearer US are located side by side, and the +Z direction corresponds to a forward or front direction of the wearer US. The ±Y directions are parallel to the vertical axis or the vertical direction.

The HMD 200 includes a first display device 100A for the right eye, a second display device 100B for the left eye, a pair of temple type support devices 100C that support the display devices 100A and 100B, and a user terminal 90 that is an information terminal. The first display device 100A includes a display driving unit 102 disposed at an upper portion thereof, and an exterior member 103 that has a spectacle lens shape and covers the front of the eye. Similarly, the second display device 100B includes a display driving unit 102 disposed at an upper portion thereof, and an exterior member 103 that has a spectacle lens shape and covers the front of the eye. Each support device 100C is a wearing member worn on the head of the wearer US and supports the upper end side of the exterior member 103 via the display driving unit 102. The first display device 100A and the second display device 100B are devices the left and the right of which are optically inverted, and a detailed description of the second display device 100B will be omitted.

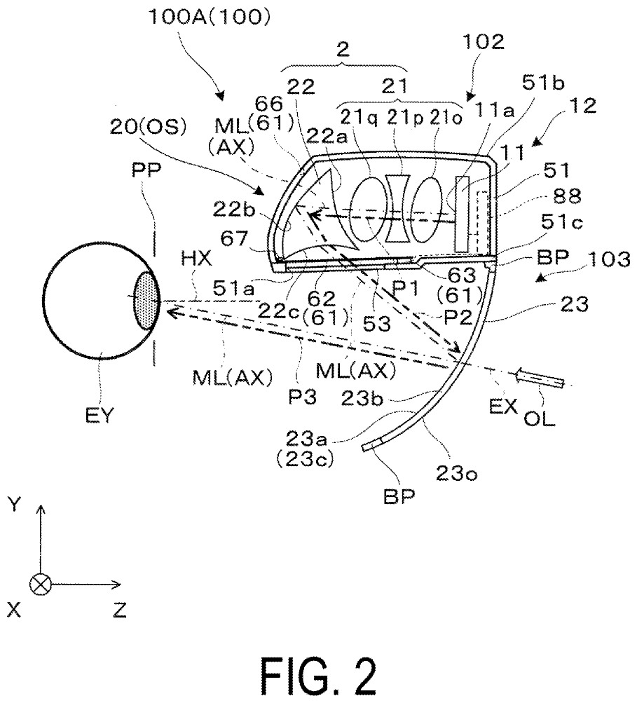

FIG. 2 is a side cross-sectional view for describing an optical structure of the first display device 100A. The first display device 100A includes a display element 11, an imaging optical system 20, a life management unit 61, and a display control device 88. The display element 11 and the display control device 88 correspond to an image forming unit. Note that only the display element 11 may be referred to as the image forming unit. The imaging optical system 20 includes a projection lens 21, a prism mirror 22, and a see-through mirror 23. In the imaging optical system 20, the projection lens 21 and the prism mirror 22 correspond to a projection optical system 2 on which video light or image light ML corresponding to a video or an image is incident, and the see-through mirror 23 corresponds to a reflection member that reflects the image light ML emitted from the projection optical system 2 toward an eye EY or a pupil position PP. The projection lens 21 and the prism mirror 22 that constitute the projection optical system 2 project, in an enlarged manner, and form an intermediate image, and the see-through mirror 23 that is a reflection member further enlarges the intermediate image formed on a light exit side of the prism mirror 22. In the imaging optical system 20, the projection lens 21 and the prism mirror 22 correspond to the display driving unit 102 illustrated in FIG. 1, and the see-through mirror 23 corresponds to the exterior member 103 illustrated in FIG. 1. A combination of the display element 11, the projection lens 21, and the prism mirror 22 is referred to as a projection optical system 12, and these components are fixed in a case 51 in a state of being mutually aligned.

The case 51 is a housing or a support member, is formed of a light-shielding material, and supports, in addition to the projection optical system 12, the display control device 88 operating the display element 11. The case 51 includes an opening 51a, an upper cover 51b, and a lower cover 51c. The upper cover 51b entirely covers the projection optical system 12 and the display control device 88. The lower cover 1c is joined to a lower end of the upper cover 51b. The opening 51a is provided in the lower cover 51c and allows the projection optical system 12 to emit the image light ML toward the outside. In the lower cover 51c, the opening 51a is provided with a transmission window 53 for protection from dust and water.

Inside the case 51 and above the lower cover 51c and the transmission window 53, a dimming member 62 of the life management unit 61 described later is provided. Although details will be described later, in order to notify the lifetime of the display element 11, the dimming member 62 can dim the image light by being subjected to an action of changing its quality so as to make it difficult for the wearer US to view the virtual image after the elapse of the lifetime of the display element 11. The dimming member 62 has optical transparency and does not reduce the light amount of the image light ML until the end of the lifetime is reached.

A sensor 66 of the life management unit 61 described later is provided outside the case 51 and on the wearer US side. The sensor 66 is attached to the case 51 that is a support member. In the example of FIG. 1, the sensor 66 is disposed at a position that is between the first display device 100A and the second display device 100B and faces the glabella of the wearer US when the wearer US wears the virtual image display device 100. Although details will be described later, the sensor 66 detects that the wearer US wears the device.

The display element 11 is a display device that emits light by itself in the projection optical system 12 illustrated in FIG. 2. The display element 11 is, for example, an organic electro-luminescence (EL) display, and forms a color still image or moving image on a two-dimensional display surface 11a. The display element 11 is driven by the display control device 88 that is a control unit to perform a display operation.

The display element 11 is not limited to the organic EL display, and can be replaced with a display device using inorganic EL, an organic LED, an LED array, a laser array, a quantum dot light emission element, or the like. The display element 11 is not limited to an image light generation device that emits light by itself and may include a liquid crystal display (LCD) or another light modulation element and form an image by illuminating the light modulation element by a light source such as a backlight. As the display element 11, a liquid crystal on silicon (LCoS) (trade name), a digital micro-mirror device, or the like may be used instead of an LCD.

The imaging optical system 20 is an off-axis optical system OS due to, for example, the see-through mirror 23 being a concave mirror. In the first embodiment, the projection lens 21, the prism mirror 22, and the see-through mirror 23 are disposed to be non-axially symmetrical and have an optical surface that is non-axisymmetric. In this imaging optical system 20, an optical axis AX is folded in the off-axis plane parallel to the YZ plane, so that the optical elements 21, 22, and 23 are arranged along the off-axis plane. In the off-axis plane parallel to the YZ plane, an optical path P1 from the projection lens 21 to an inner reflection surface 22b, an optical path P2 from the inner reflection surface 22b to the see-through mirror 23, and an optical path P3 from the see-through mirror 23 to the pupil position PP are folded back twice in a Z shape. In this case, the optical elements 21, 22, and 23 constituting the first display device 100A are arranged so that height positions thereof are changed in the longitudinal direction, and thus an increase in the width of the first display device 100A can be prevented.

In the imaging optical system 20, the projection lens 21 includes a first lens 21o, a second lens 21p, and a third lens 21q. The projection lens 21 receives the image light ML emitted from the display element 11 and makes the image light ML incident on the prism mirror 22. The projection lens 21 focuses the image light ML emitted from the display element 11 into a state close to a parallel luminous flux. The prism mirror 22 includes an incident surface 22a corresponding to an incident portion, the inner reflection surface 22b corresponding to a reflection portion, and an exit surface 22c corresponding to an exit portion. The prism mirror 22 emits the image light ML incident from the front such that the image light ML is folded back in a direction inclined downward with respect to a direction reverse to an incident direction (a direction of the light source seen from the prism mirror 22). The see-through mirror 23 includes a reflection surface 23a and an outside surface 23o. The see-through mirror 23 enlarges an intermediate image formed on the light exit side of the prism mirror 22.

The optical surfaces, that is, the incident surfaces and the exit surfaces of the first lens 21o, the second lens 21p, and the third lens 21q constituting the projection lens 21 are asymmetric with respect to the optical axis AX in the longitudinal direction that is parallel to the YZ plane and intersects the optical axis AX and symmetric with respect to the optical axis AX in the transverse direction or the X direction. The optical surfaces of the first lens 21o, the second lens 21p, and the third lens 21q are, for example, free form surfaces. The optical surfaces are not limited to free form surfaces and may be aspheric surfaces. Making the optical surfaces free form surfaces or aspheric surfaces allows aberration reduction. The first lens 21o, the second lens 21p, and the third lens 21q are formed of optical resin but may also be formed of glass. An antireflection film can be formed at the optical surfaces of the first lens 21o, the second lens 21p, and the third lens 21q.

The prism mirror 22 is a refractive and reflective optical member having a function obtained by combining a mirror and a lens, and reflects the image light ML from the projection lens 21 while refracting the image light ML. Specifically, in the prism mirror 22, the image light ML is incident on the inside through the incident surface 22a, the incident image light ML is totally reflected in a non-forward direction by the inner reflection surface 22b, and the incident image light ML is emitted toward the outside through the exit surface 22c. The incident surface 22a, the inner reflection surface 22b, and the exit surface 22c that are the optical surfaces constituting the prism mirror 22 are asymmetric with respect to the optical axis AX in the longitudinal direction that is parallel to the YZ plane and intersects the optical axis AX and symmetric with respect to the optical axis AX in the transverse direction or the X direction. The prism mirror 22 may be formed of, for example, optical resin, but may also be formed of glass. The optical surfaces of the prism mirror 22, that is, the incident surface 22a, the inner reflection surface 22b, and the exit surface 22c are, for example, free form surfaces. The incident surface 22a, the inner reflection surface 22b, and the exit surface 22c are not limited to free form surfaces and may be aspheric surfaces. In the prism mirror 22, the aberration can be reduced by making the optical surfaces 22a, 22b, and 22c free form surfaces or aspheric surfaces, and, in particular, when free form surfaces are used, the optical performance of an eccentric system is easily improved. The inner reflection surface 22b is not limited to one that reflects the image light ML by total reflection, and may be a reflection surface formed of a metal film or a dielectric multilayer film. In this case, a reflection film including a single layer film or multilayer film formed of a metal such as Al or Ag is formed on the inner reflection surface 22b by vapor deposition or the like, or a sheet-shaped reflection film formed of a metal is affixed thereto. Although detailed illustration is omitted, an antireflection film is formed on the incident surface 22a and the exit surface 22c.

The see-through mirror 23 is a curved plate-shaped reflection optical member that serves as a concave surface mirror, and reflects the image light ML from the prism mirror 22. That is, the see-through mirror 23 reflects, toward the pupil position PP, the image light ML from the prism mirror 22 disposed in an exit region of the projection optical system 12. The see-through mirror 23 covers the pupil position PP at which the eye EY or the pupil is located, has a concave shape toward the pupil position PP, and has a convex shape toward the outside. The see-through mirror 23 is a concave transmission mirror that covers an entire effective area of a screen in the field of view. The see-through mirror 23 is a collimator having a convergence function and converges, to the pupil position PP, the main beams of the image light ML emitted from the respective points at the display surface 11a and spread once by imaging in the vicinity of the exit side of the prism mirror 22 of the projection optical system 12. The see-through mirror 23 is a mirror plate having a structure in which a mirror film 23c that is a half mirror having transparency is formed on a front surface or a rear surface of a plate-shaped body 23b that is a base. The reflection surface 23a of the see-through mirror 23 is asymmetric with respect to the optical axis AX in the longitudinal direction that is parallel to the YZ plane and intersects the optical axis AX and symmetric with respect to the optical axis AX in the transverse direction or the X direction. The reflection surface 23a of the see-through mirror 23 is, for example, a free form surface. The reflection surface 23a is not limited to a free form surface and may be an aspheric surface. The aberration can be reduced by making the surface of the see-through mirror 23 a free form surface or an aspheric surface, and, in particular, when a free form surface is used, the aberration of the imaging optical system 20 that is an off-axis optical system OS or a non-coaxial optical system can be easily reduced.

The see-through mirror 23 is a transmissive reflection element that allows transmission of some of light upon reflection, and the reflection surface 23a or the mirror film 23c of the see-through mirror 23 is formed of a reflection layer having a semi-transmissive property. Thus, because outside light OL passes through the see-through mirror 23, see-through view of the outside is enabled, and a virtual image can be superimposed on an outside image. At this time, when the plate-shaped body 23b supporting the mirror film 23c is as thin as substantially several millimeters, a change in magnification of the outside image can be reduced. A reflectance of the image light ML and the outside light OL through the mirror film 23c is set to 10% or more and 50% or less in a range of an incident angle of the expected image light ML from the viewpoint of maintaining a luminance of the image light ML and facilitating observation of the outside image in a see-through manner.

In the first embodiment, the plate-shaped body 23b that is the base of the see-through mirror 23 is an environment-conscious member EM and is formed of an environment-conscious material. Here, the environment-conscious material is an organic resource including a raw material of plant origin, and is, for example, biomass plastic. The environment-conscious material may be a biodegradable plastic or a non-biodegradable plastic. Examples of the biodegradable plastic include amorphous polylactic acid (PLA) and polyhydroxybutyrate (PHB). Examples of the non-biodegradable plastic include biopolyethylene (PE) and biopolyethylene terephthalate (PET). The plate-shaped body 23b has the same thickness as a support plate BP that supports the plate-shaped body 23b from the surrounding thereof. The support plate BP is formed of the same material as the plate-shaped body 23b.

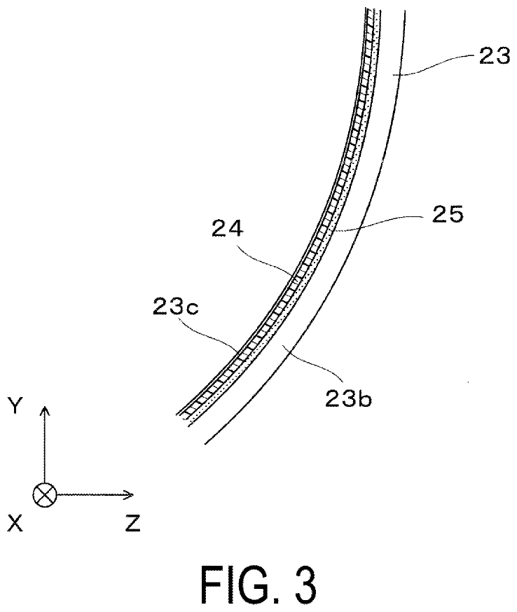

As illustrated in FIG. 3 in an enlarged manner, the mirror film 23c that is a half mirror is affixed to the plate-shaped body 23b of the see-through mirror 23 via a peelable film 24. Accordingly, when the virtual image display device 100 is discarded, the half mirror portion that is a functional film, namely, the mirror film 23c and the film 24 can be easily removed from the see-through mirror 23, and the plate-shaped body 23b that is the environment-conscious member EM can be easily reproduced. The film 24 is a sheet having optical transparency and is affixed to the front surface of the plate-shaped body 23b by, for example, a double-sided optical clear adhesive (OCA) tape 25. The OCA tape 25 is formed of an elastomer. The film 24 includes the mirror film 23c on a surface opposite to a surface to be affixed to the plate-shaped body 23b. That is, the film 24 serves as a support of the mirror film 23c. The mirror film 23c is formed on the film 24 by vapor deposition or the like. Although the film 24, the OCA tape 25, the mirror film 23c, and the like illustrated in FIG. 3 are illustrated thickly for convenience of description, these components are actually relatively thin films having a thickness of several hundred μm or less as a whole.

The mirror film 23c is formed of, for example, a dielectric multilayer film including a plurality of dielectric layers having an adjusted film thickness. The mirror film 23c may be a single layer film or a multilayer film formed of a metal such as Al or Ag and having an adjusted film thickness. The mirror film 23c can be formed by layering. The mirror film 23c may include a hard coat layer as a base or a coating.

Although not illustrated in the drawing, a hard coat layer or an antireflection film may be formed at the outside surface 23o of the plate-shaped body 23b. In a manner similar to the mirror film 23c, the antireflection film may be disposed via the peelable film 24, or may be directly disposed on the outside surface 23o when the antireflection film has little environmental influence. Further, the antireflection film does not need to be provided at the outside surface 23o.

In describing the optical path, the image light ML from the display element 11 is incident on the projection lens 21 and is emitted from the projection lens 21 in a state of being substantially collimated. The image light ML that has passed through the projection lens 21 is incident on the prism mirror 22, passes through the incident surface 22a while being refracted, is reflected by the inner reflection surface 22b with a high reflectance of substantially 100%, and is refracted again by the exit surface 22c. The image light ML from the prism mirror 22 is incident on the see-through mirror 23 and is reflected by the reflection surface 23a with a reflectance of substantially 50% or less. The image light ML reflected by the see-through mirror 23 is incident on the pupil position PP at which the eye EY or pupil of the wearer US is placed. The outside light OL that has passed through the see-through mirror 23 and the support plate BP therearound is also incident on the pupil position PP. In other words, the wearer US wearing the first display device 100A can observe a virtual image of the image light ML superimposed on the outside image. The dimming member 62 does not dim the image light ML until the end of the lifetime of the virtual image display device 100 is reached. Although details will be described later, when the end of the lifetime is reached, the quality of the dimming member 62 is changed under control of the display control device 88. Thus, the image light ML passing through the dimming member 62 is dimmed, the virtual image becomes less visible, and the wearer US can recognize that the end of the lifetime of the virtual image display device 100 is reached. That is, optical deterioration of the first display device 100A can be clearly recognized visually. It is typically difficult to determine deterioration of the first display device 100A, to be specific, the display element 11. However, by intentionally making a virtual image less visible after the elapse of the lifetime, even a common user can easily determine that the end of the lifetime has been reached.

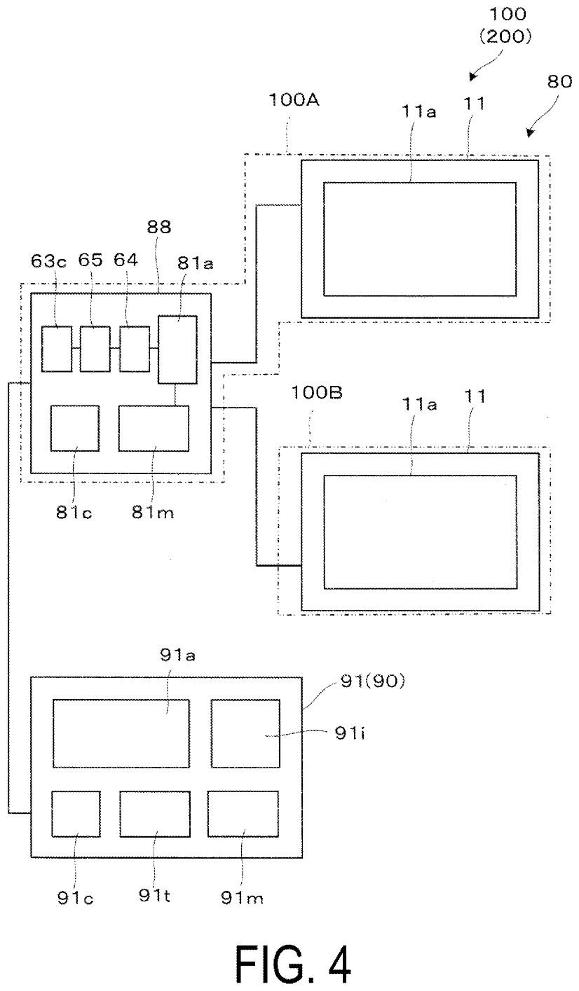

A circuit system 80 of the HMD 200, that is, the virtual image display device 100 will be described with reference to FIG. 4. The HMD 200 includes, as the circuit system 80, the display control device 88, the pair of display elements 11, and a user terminal circuit 91. One of the display elements 11 is incorporated in the first display device 100A, and the other of the display elements 11 is incorporated in the second display device 100B. The display control device 88 functions as a control unit. In the illustrated example, the display control device 88 is illustrated as being incorporated in the first display device 100A, but may be independent of the first display device 100A and the second display device 100B. A combination of one of the first display device 100A and the second display device 100B and the display control device 88 is also referred to as the virtual image display device 100 and displays a virtual image for one eye. The first display device 100A will be described below.

The display control device 88 includes an arithmetic processing device 81a, a storage device 81m, and a data communication interface 81c. The display control device 88 includes a heating control unit 63c, a life count unit 64, and a life determination unit 65. The heating control unit 63c, the life count unit 64, and the life determination unit 65 constitute the life management unit 61 described later.

The storage device 81m stores a program for causing the first display device 100A and the second display device 100B to perform display operations. The storage device 81m stores an image acquired from the user terminal 90 that is an information terminal, an image generated by the arithmetic processing device 81a, and the like. The storage device 81m includes a frame memory.

The display control device 88 causes the display element 11 to perform a display operation while managing the cumulative display time of the display element 11.

The display control device 88 receives display data corresponding to image data from the user terminal circuit 91 via the data communication interface 81c. The display control device 88 outputs the image data that is the display data stored in the frame memory to the display element 11 via the data communication interface 81c.

The user terminal circuit 91 is incorporated in the user terminal 90 and includes a main control device 91a, a storage device 91m, a data communication interface 91c, a mobile wireless communication device 91t, and a user interface device 91i. The user terminal circuit 91 can communicate with various devices such as an external server via a communication network (not illustrated) by using the mobile wireless communication device 91t. The storage device 91m stores a basic program for operating the user terminal circuit 91, and stores a plurality of application software programs including, for example, a viewer for replaying moving images and a web browser as application software programs operating on the basic program. The user terminal circuit 91 operates in response to a request from the user interface device 91i operated by the user and outputs, to the display control device 88 in a predetermined format, moving images and still images stored in the storage device 91m in association with the application software programs, or acquires moving images and still images corresponding to various contents via the mobile wireless communication device 91t and outputs the acquired display date to the display control device 88 in a predetermined format.

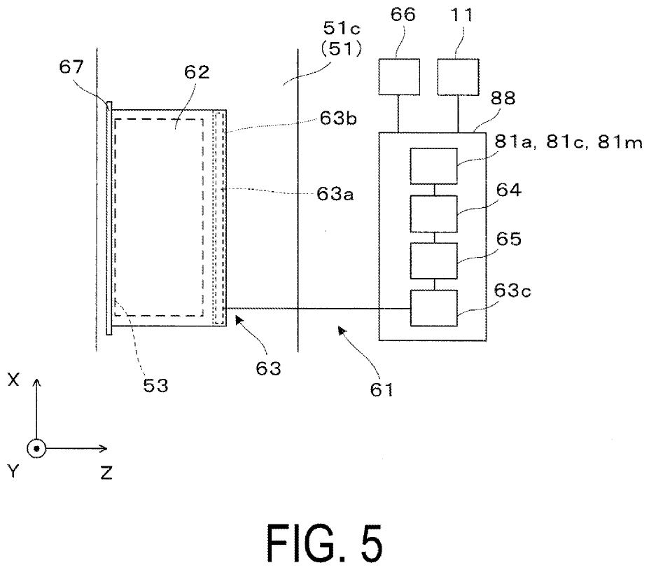

Hereinafter, the life management unit 61 using the dimming member 62 will be described with reference to FIGS. 2 and 5.

As illustrated in FIG. 5, the life management unit 61 includes the dimming member 62, a heating unit 63, the life count unit 64, the life determination unit 65, and the sensor 66. FIG. 5 schematically illustrates the dimming member 62 and the heating unit 63 of the life management unit 61 as viewed from the vertical direction, specifically, the +Y direction.

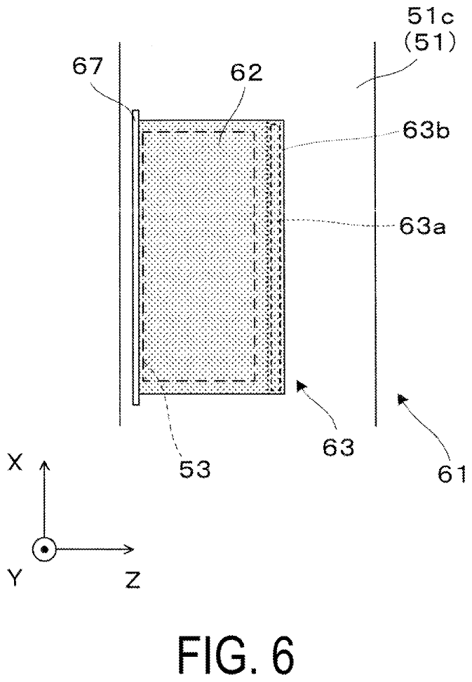

The dimming member 62 can visually notify the lifetime of the display element 11 by changing the transmission state of the image light ML. After the elapse of the lifetime of the display element 11, that is, the lifetime of the virtual image display device 100, when the dimming member 62 is subjected to an action of changing the quality of the dimming member 62 so that the dimming member 62 dims the image light ML, a projected virtual image becomes less visible, and even a common user can easily determine that the end of the lifetime has been reached. Examples of the change of the quality of the dimming member 62 for dimming light include clouding of the dimming member 62 by heating as illustrated in FIG. 6 or deforming of the dimming member 62 (not illustrated). When the dimming member 62 is relatively thick, it is preferable to cloud the dimming member 62. When the dimming member 62 is relatively thin, it is preferable to deform the dimming member 62. Both phenomena of clouding and deformation may occur in accordance with the thickness of the dimming member 62.

The life management unit 61 clouds the dimming member 62 by using the heating unit 63 after the elapse of the lifetime expected for the display element 11. In this case, the internal refractive index of the dimming member 62 changes, the transmittance decreases, and the luminance of the image decreases. Thus, the projected virtual image becomes less visible. In addition, the life management unit 61 deforms the dimming member 62 by using the heating unit 63 after the elapse of the expected lifetime of the display element 11. In this case, the internal refractive index of the dimming member 62 changes, the image is disturbed, and the projected virtual image becomes less visible.

As illustrated in FIG. 2, the dimming member 62 is provided in the case 51 as described above and disposed on an optical path between the display element 11 that is an image forming unit and the pupil position PP. Specifically, the dimming member 62 is disposed in the case 51 on an optical path between the projection optical system 12 and the see-through mirror 23. Thus, the dimming member 62 can be stably disposed.

The dimming member 62 is a film-like or sheet-like member and has a substantially constant thickness. The dimming member 62 has a thickness of 0.2 mm or less. The dimming member 62 preferably has a thickness of 0.03 mm or more and 0.2 mm or less.

The dimming member 62 has such a rectangular shape as to cover the entire transmission window 53, and one of four sides of the dimming member 62 is coupled to a heating element 63a of the heating unit 63, which will be described later, at a bottom surface portion. The heating element 63a is fixed to the lower cover 51c. Among the four sides of the dimming member 62, three sides not coupled to the heating element 63a are not fixed to any component and the dimming member 62 may be lightly pressed from above so that the position of the dimming member 62 is not displaced. In the illustrated example, the one side of the dimming member 62 facing the heating element 63a is lightly pressed by a pressing portion 67. If only one side of the dimming member 62 is fixed, deformation of the dimming member 62 is not prevented. When the dimming member 62 is clouded and thus light is dimmed, the dimming member 62 may be completely fixed.

The dimming member 62 is formed of an environment-conscious material. Among biomass plastics, examples of the environment-conscious material of the dimming member 62 include amorphous polylactic acid. Polylactic acid (PLA) can be easily chemically synthesized from lactic acid of plant origin. In the dimming member 62, when the polylactic acid is amorphous, the polylactic acid is clouded due to microcrystallization accompanying heating to a predetermined temperature, the image light ML from the display element 11 is dimmed or blurred, and the use of the virtual image display device 100 is reversibly limited.

The heating unit 63 includes the heating element 63a coupled to the dimming member 62, a heat insulating member 63b, and the heating control unit 63c. The heating unit 63 causes a current to flow through the heating element 63a to heat the heating element 63a under control of the heating control unit 63c. The heating element 63a is a heater that generates heat by being supplied with a current and is formed of, for example, a nichrome wire. The heat insulating member 63b is disposed so as to cover the heating element 63a and prevents heat of the heating element 63a from being transferred to the surroundings during heating. Examples of the heat insulating member 63b include foamed plastic. The heating control unit 63c is provided to accompany the display control device 88 and controls the operation of the heating element 63a.

The life count unit 64 adds up the operation time of the display element 11. The life count unit 64 is provided to accompany the display control device 88, for example. As a circuit configuration, the life count unit 64 is an electronic component that counts the cumulative display time of the display element 11. Here, the lifetime is, for example, a time it takes for the luminance of the image formed by the display element 11 to be reduced by half. The lifetime may be set in advance by a manufacturer, or the luminance of the image displayed by the display element 11 may be detected by a sensor (not illustrated) or the like.

The life determination unit 65 determines whether the operation time added up by the life count unit 64 exceeds a predetermined lifetime (for example, a time it takes for the luminance to be reduced by half). Specifically, when the operation time of the display element 11 is the predetermined time, the life determination unit 65 determines that the expected lifetime of the display element 11 has been elapsed. When determining that the lifetime of the display element 11 has elapsed, the life determination unit 65 operates the heating unit 63 to heat the dimming member 62 and changes the quality of the dimming member 62 so that the dimming member 62 is brought into a dimming state in which the image light ML is dimmed.

The sensor 66 detects that the wearer US wears the device. The display element 11 operates when the sensor 66 detects that the wearer US wears the device. Specifically, when detecting that the wearer US wears the virtual image display device 100, the sensor 66 outputs a detection signal to the display control device 88. When receiving the detection signal, the display control device 88 operates the display element 11. In this case, the display time of the image on the display element 11 corresponds to the cumulative time of the lifetime. Accordingly, the operation of the display element 11 and the wearing by the wearer US are coordinated, and the life of the display element 11 can be appropriately managed. Examples of the sensor 66 include a proximity sensor. As long as the sensor 66 can detect that the wearer US wears the virtual image display device 100, the sensor 66 may be disposed at a position other than the position illustrated in FIG. 1 and the like and may be disposed at, for example, the support device 100C that is a wearing member.

When the cumulative display time of the display element 11 reaches a preset cumulative time (lifetime), the life management unit 61 operates the heating control unit 63c under control of the life determination unit 65 and causes a current to flow through the heating element 63a coupled to the dimming member 62 to heat the heating element 63a. The heat of the heating element 63a is transferred to the dimming member 62, and the dimming member 62 is clouded or deformed by the heat. The image or video displayed on the display element 11 is transmitted through the dimming member 62 from the projection optical system 12, reflected by the see-through mirror 23, and displayed as a virtual image. Thus, due to dimming by the dimming member 62, the virtual image becomes less visible, and it is possible to notify the wearer US of the life of the display element 11, that is, the virtual image display device 100. Accordingly, it is possible to manage a plurality of the virtual image display devices 100 without checking the lifetime of each virtual image display device 100. As described above, when the display element 11 reaches the end of the life, the image quality or the video quality is significantly degraded. Thus, in the management of the devices, it is not necessary to check the cumulative time for each device.

The virtual image display device 100 according to the first embodiment described above includes the image forming unit 11, the projection optical system 2 on which the image light ML formed by the image forming unit 11 is incident, the reflection member 23 that reflects the image light ML emitted from the projection optical system 2 and projects the virtual image, and the support member 51 that supports the image forming unit 11, the projection optical system 2, and the reflection member 23. A part of the projection optical system 2 and the reflection member 23 is the environment-conscious member EM formed of the environment-conscious material.

In the above virtual image display device 100, at least a part of the projection optical system 2 and the reflection member 23 as the optical members is the environment-conscious members EM, which can facilitates regeneration when the virtual image display device 100 is discarded.

The virtual image display device 100 includes the dimming member 62 that is disposed on the optical path between the image forming unit 11 and the pupil position PP, has optical transparency, and can be changed into the dimming state in which the image light ML is dimmed under an influence of an external action, and the dimming member 62 is formed of the environment-conscious material. Accordingly, after the elapse of the lifetime of the image forming unit 11, when the dimming member 62 is subjected to an action of changing the quality of the dimming member 62 so that the dimming member 62 dims the image light ML, the projected virtual image becomes less visible, and even a common user can easily determine that the end of the lifetime has been reached. In addition, the dimming member 62 is formed of the environment-conscious material, which can facilitate regeneration when the virtual image display device 100 is discarded.

As described above, in the virtual image display device 100, the constituent element of the virtual image display device 100, specifically, the projection optical system 2, the reflection member 23, or the dimming member 62 is the environment-conscious member EM or formed of the environment-conscious material, and the environment-conscious member EM is separable from the virtual image display device 100. Thus, it is easy to make eco-friendly design for reuse, recycling, and sorting. In addition to regenerating or reusing the environment-conscious member EM as it is, for example, when the functional film or the like is configured to be peeled from the environment-conscious member EM or the environment-conscious material, or when the environment-conscious member EM or the environment-conscious material itself is configured to be peeled from the base or the like, the environment-conscious member EM or the environment-conscious material can be easily separated and regenerated or reused.

### Second Embodiment

A virtual image display device according to a second embodiment of the present disclosure will be described below. The virtual image display device according to the second embodiment is a partial modification of the virtual image display device according to the first embodiment and description of common parts will be omitted.

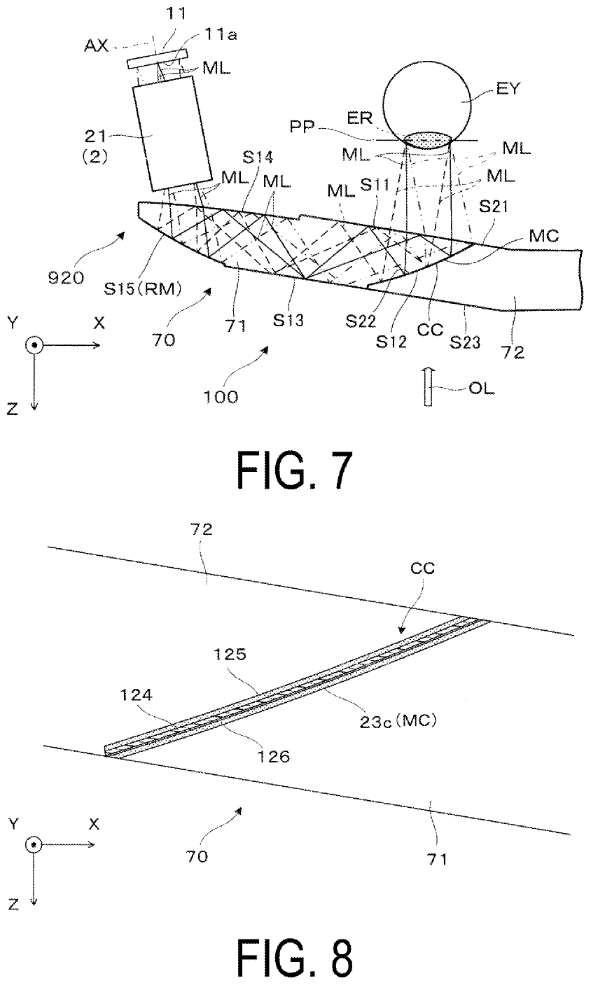

FIG. 7 is a side cross-sectional view for describing an internal structure of a virtual image display device 100 according to the second embodiment. As illustrated in FIG. 7, the virtual image display device 100 includes the display element 11 and an imaging optical system 920. The imaging optical system 920 is an off-axis optical system, but its optical path extends in the transverse direction while being reflected, unlike the first embodiment. The imaging optical system 920 is a light guide optical device and includes the projection lens 21 and a light guide 70. In the second embodiment, the projection lens 21 corresponds to the projection optical system 2, and the light guide 70 corresponds to the reflection member. The light guide 70 is formed by joining a light guide member 71 and a light transmission member 72 via an adhesive layer CC. The light guide member 71 and the light transmission member 72 are formed of a resin material that exhibits high optical transparency in a visible region. Specifically, the light guide member 71 and the light transmission member 72 are environment-conscious members EM formed of an environment-conscious material. Note that one of the light guide member 71 and the light transmission member 72 may be the environment-conscious member EM. The light guide member 71 has first to fifth surfaces S11 to S15. Among these surfaces, the first and third surfaces S11 and S13 are flat surfaces parallel to each other, and the second, fourth, and fifth surfaces S12, S14, and S15 are convex optical surfaces as a whole and are formed of free form surfaces, for example. The light transmission member 72 has first to third transmission surfaces S21 to S23. Among these surfaces, the first and third transmission surfaces S21 and S23 are flat surfaces parallel to each other, and the second transmission surface S22 is a concave optical surface as a whole and is formed of a free form surface, for example. The second surface S12 of the light guide member 71 and the second transmission surface S22 of the light transmission member 72 have an equal shape in which a recess and a protrusion are inverted, and a partial reflection surface MC is formed at a surface of one of them.

As illustrated in FIG. 8 in an enlarged manner, a film 124 including the mirror film 23c is peelably affixed between the light guide member 71 and the light transmission member 72 in the light guide 70. Accordingly, when the virtual image display device 100 is discarded, the half mirror portion that is a functional film can be easily removed from the light guide 70, and the light guide member 71 and the light transmission member 72 that are the environment-conscious members EM can be easily reproduced. In the second embodiment, in the light guide 70 corresponding to the reflection member, the main bodies of the light guide member 71 and the light transmission member 72 correspond to the base. The mirror film 23c is formed on one surface of the film 124 by vapor deposition or the like. The double-sided OCA tapes 125 and 126 are provided on both sides of the film 124. That is, in the adhesive layer CC between the light guide member 71 and the light transmission member 72, the first OCA tape 125, the mirror film 23c, the film 124, and the second OCA tape 126 are disposed in this order from the light guide member 71 side. The mirror film 23c corresponds to the partial reflection surface MC illustrated in FIG. 7. Although the film 124, the OCA tapes 125 and 126, the mirror film 23c, and the like illustrated in FIG. 8 are thickly illustrated for convenience of description, these components are actually relatively thin films.

Although not illustrated, a hard coat layer or an antireflection film may be formed at the outside surface of the light guide 70.

An overview of the optical path of the image light ML will be described below. The light guide member 71 guides the image light ML emitted from the projection lens 21 toward the eye of the wearer by reflection at the first to fifth surfaces S11 to S15 and the like. Specifically, the image light ML from the projection lens 21 is first incident on the fourth surface S14, is reflected by the fifth surface S15 that is an inner surface of a reflection film RM, is incident again on the fourth surface S14 from the inside and totally reflected, is incident on the third surface S13 and totally reflected, and is incident on the first surface S11 and totally reflected. The image light ML totally reflected by the first surface S11 is incident on the second surface S12, and is partially reflected while partially transmitted through the partial reflection surface MC provided at the second surface S12, and is incident again on the first surface S1l and passes therethrough. The image light ML that has passed through the first surface S11 is incident as a substantially parallel luminous flux on the pupil position PP at which the eye EY of the wearer is located. That is, the wearer observes an image by the image light ML serving as a virtual image.

The light guide 70 is configured to allow the wearer to visually recognize the image light ML by the light guide member 71, and to allow the wearer to observe an outside image with little distortion in a state in which the light guide member 71 and the light transmission member 72 are combined. At this time, because the third surface S13 and the first surface S11 are flat surfaces substantially parallel to each other (diopter is substantially zero), little aberration or the like is generated for the outside light OL. Furthermore, the third transmission surface S23 and the first transmission surface S21 are flat surfaces substantially parallel to each other. Furthermore, because the third transmission surface S23 and the first surface S11 are flat surfaces substantially parallel to each other, little aberration or the like is generated. As described above, the wearer observes an outside image without distortion through the light guide member 71 and the light transmission member 72.

Although not illustrated, in the second embodiment, a dimming member may be provided on the exit side of the projection lens 21. The dimming member can have the same configuration as that of the first embodiment.

### Third Embodiment

A virtual image display device according to a third embodiment of the present disclosure will be described below. The virtual image display device according to the third embodiment is a partial modification of the virtual image display device according to the first embodiment and description of common parts will be omitted.

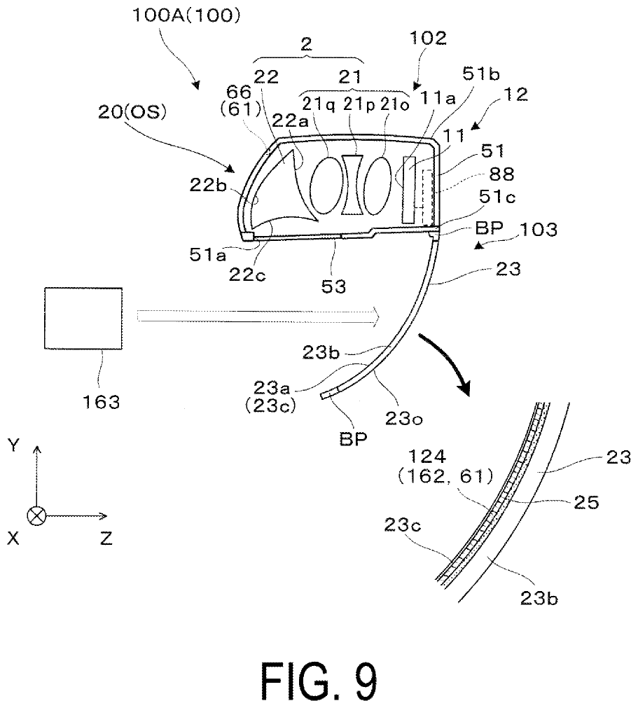

As illustrated in FIG. 9, in the third embodiment, the film 24 interposed in the mirror film 23c of the see-through mirror 23 may be used as a dimming member 162 instead of the dimming member 62 illustrated in FIG. 2. In other words, the dimming member 162 is peelably affixed to the plate-shaped body 23b of the see-through mirror 23. Accordingly, when the virtual image display device 100 is discarded, the dimming member 162 can be easily removed from the see-through mirror 23.

In the third embodiment, a heating unit 163 is an external device. The heating unit 163 directly heats the dimming member 162 or irradiates the dimming member 162 with light. In the illustrated example, the heating unit 163 heats the dimming member 162 by irradiating the dimming member 162 with, for example, infrared light.

Similarly, in the virtual image display device 100 according to the second embodiment, the film 124 constituting the adhesive layer CC of the light guide 70 may be used as the dimming member.

### Modified Examples and Others

Although the present disclosure has been described with reference to the above embodiments, the present disclosure is not limited to the above embodiments and can be implemented in various modes without departing from the spirit of the disclosure. For example, the following modifications are possible.

In the above-described embodiment, the optical member serving as the environment-conscious member EM is only required to be at least a part of the projection optical system 2 and the see-through mirror 23 that is a reflection member. In the members constituting the projection optical system 2, an optical member serving as the environment-conscious member EM is a light transmissive member through which the image light ML passes. Specifically, the projection lens 21 and the prism mirror 22 constituting the projection optical system 2 may be the environment-conscious members EM. In this case, the see-through mirror 23 does not need to be the environment-conscious member EM, and the see-through mirror 23 may be formed of resin or glass other than the environment-conscious material. Alternatively, all of the projection lens 21, the prism mirror 22, and the see-through mirror 23 may be the environment-conscious members EM. Even when the projection lens 21 and the prism mirror 22 are the environment-conscious members EM, it is preferable that a functional film such as an antireflection film or a reflection film is affixed to the base via a peelable film as in the case of the see-through mirror 23. In addition, the case 51 that is a support member and the transmission window 53 may be the environment-conscious members EM. In this case, the transmission window 53 may be included in a member constituting the projection optical system 12.

In the above-described embodiment, the dimming member 62 may be provided at the projection lens 21 or the prism mirror 22 of the projection optical system 2. In this case, for example, in a manner similar to the see-through mirror 23, a film-like dimming member is affixed to the optical surface. In addition, the transmission window 53 or the plate-shaped body 23b of the see-through mirror 23 may be the dimming member 62. In this case, since the dimming member 62 is relatively thick, the dimming member 62 is clouded when the quality is changed for dimming of the image light ML. Further, although one dimming member 62 is provided, two or more dimming members 62 may be provided.

In the above-described embodiment, the dimming member 62 may be provided at both the first display device 100A and the second display device 100B or may be provided at only one of the first display device 100A and the second display device 100B.

In the above-described embodiment, the life count unit 64 does not need to be provided, and the life count unit 64 may be managed by an external device.

In the above-described embodiment, the heating unit 63 may be a light source such as a laser and may locally heat the dimming member 62.

In the embodiment described above, the virtual image display device 100 does not need to be provided with the dimming member 62.

In the embodiment described above, the virtual image display device 100 does not need to be provided with the sensor 66 for detection of wearing.

In the embodiment described above, in the virtual image display device 100, at least a part of the projection optical system 2 and the see-through mirror 23 that is a reflection member does not need to be the environment-conscious member EM.

In the above-described embodiment, the heating control unit 63c, the life count unit 64, and the life determination unit 65 accompany the display control device 88. However, these units may be configured as separate circuit configurations.

In the first display device 100A, the projection lens 21 is configured of three lenses, but may be configured of one, two, four or more lenses. Further, the first display device 100A does not need to be provided with the projection lens 21.

A light control device that controls light by limiting light transmitted through the see-through mirror 23 may be mounted on the outside of the see-through mirror 23. The light control device adjusts a transmittance, for example, electrically. A mirror liquid crystal, an electronic shade, or the like may be used as the light control device. The light control device may adjust a transmittance according to outside light brightness.

A virtual image display device according to a specific aspect includes an image forming unit, a projection optical system on which image light formed by the image forming unit is incident, and a reflection member configured to reflect the image light emitted from the projection optical system and project a virtual image, wherein at least a part of the projection optical system and the reflection member is an environment-conscious member formed of an environment-conscious material.

In the above virtual image display device, at least a part of the projection optical system and the reflection member as the optical members is the environment-conscious member, which can facilitate regeneration when the virtual image display device is discarded.

In a specific aspect, the environment-conscious material of the environment-conscious member is biomass plastic.

In a specific aspect, the environment-conscious material of the environment-conscious member is any of amorphous polylactic acid, polyhydroxybutyrate, biopolyethylene, and biopolyethylene terephthalate.

In a specific aspect, the reflection member includes a base formed of the environment-conscious member, and a half mirror is affixed to the base via a peelable film. In this case, when the virtual image display device is discarded, the half mirror portion can be easily removed from the reflection member, which can facilitates regeneration of the base that is the environment-conscious member.

In a specific aspect, provided is a dimming member disposed on an optical path between the image forming unit and a pupil position, the dimming member having optical transparency and being configured to transition to a dimming state of dimming the image light under an influence of an external action. In this case, after the elapse of the lifetime of the image forming unit, when the dimming member is subjected to an action of changing the quality of the dimming member so that the dimming member dims the image light, the projected virtual image becomes less visible, and even a common user can easily determine that the end of the lifetime has been reached.

In a specific aspect, provided is a support member configured to support the image forming unit, the projection optical system, and the reflection member, wherein the dimming member is disposed on an optical path between the projection optical system and the reflection member in the support member. In this case, the dimming member can be stably disposed.

In a specific aspect, the dimming member is peelably affixed to the base of the reflection member. In this case, when the virtual image display device is discarded, the dimming member can be easily removed from the reflection member.

In a specific aspect, the dimming member is formed of an environment-conscious material. In this case, it is possible to facilitate regeneration when the virtual image display device is discarded.

In a specific aspect, the environment-conscious material of the dimming member is amorphous polylactic acid.

In a specific aspect, the dimming member has a thickness of 0.2 mm or less.

In a specific aspect, the dimming member is clouded by the heating unit after an elapse of a lifetime of the image forming unit. In this case, the internal refractive index of the dimming member changes, the transmittance decreases, and the luminance of the image decreases. Thus, the projected virtual image becomes less visible.

In a specific aspect, the dimming member is deformed by the heating unit after an elapse of a lifetime of the image forming unit. In this case, the internal refractive index of the dimming member changes, the image is disturbed, and the projected virtual image becomes less visible.

In a specific aspect, the heating unit includes a heating element coupled to the dimming member, the heating unit causing a current to flow through the heating element, thereby heating the heating element.

In a specific aspect, the heating unit is an external device and directly heats the dimming member or irradiates the dimming member with light.

In a specific aspect, provided are a life count unit configured to add up an operation time of the image forming unit, and a life determination unit configured to determine whether the operation time added up by the life count unit exceeds a lifetime predetermined. When the operation time of the image forming unit is the predetermined time, the end of the lifetime of the image forming unit is reached, and the dimming member is changed in quality so as to dim the image light. Thus, it is possible to manage a plurality of the virtual image display devices without checking the lifetime of each virtual image display device.

In a specific aspect, the lifetime is a time required for a luminance of an image formed by the image forming unit to reduce by half.

In a specific aspect, provided is a sensor configured to detect a wearer wearing the virtual image display device, wherein the image forming unit operates when the sensor detects the wearer wearing the virtual image display device. In this case, it is possible to appropriately manage the lifetime of the image forming unit by coordinating the operation of the image forming unit and the wearing by the wearer.

A virtual image display device according to a specific aspect includes an image forming unit, a projection optical system on which image light formed by the image forming unit is incident, a reflection member configured to reflect the image light emitted from the projection optical system and project a virtual image, and a dimming member disposed on an optical path between the image forming unit and the virtual image, the dimming member having optical transparency and being configured to transition to a dimming state of dimming the image light under an influence of an external action, wherein the dimming member is formed of an environment-conscious material.

In the virtual image display device, after the elapse of the lifetime of the image forming unit, when the dimming member is subjected to an action of changing the quality of the dimming member so that the dimming member dims the image light, the projected virtual image becomes less visible, and even a common user can easily determine that the end of the lifetime has been reached. In addition, the dimming member is formed of the environment-conscious material, which can facilitate regeneration when the virtual image display device is discarded.

What is claimed is:

1. A virtual image display device comprising:
an image forming unit;
a projection optical system on which image light formed by the image forming unit is incident; and
a reflection member configured to reflect the image light emitted from the projection optical system and project a virtual image, wherein
at least a part of the projection optical system and the reflection member is an environment-conscious member formed of an environment-conscious material.

2. The virtual image display device according to claim 1, wherein the environment-conscious material of the environment-conscious member is biomass plastic.

3. The virtual image display device according to claim 2, wherein the environment-conscious material of the environment-conscious member is any of amorphous polylactic acid, polyhydroxybutyrate, biopolyethylene, and biopolyethylene terephthalate.

4. The virtual image display device according to claim 1, wherein
the reflection member includes a base formed of the environment-conscious member, and
a half mirror is affixed to the base via a peelable film.

5. The virtual image display device according to claim 1, further comprising a dimming member disposed on an optical path between the image forming unit and a pupil position, the dimming member having optical transparency and being configured to transition to a dimming state of dimming the image light under an influence of an external action.

6. The virtual image display device according to claim 5, further comprising a support member configured to support the image forming unit, the projection optical system, and the reflection member, wherein
the dimming member is disposed on an optical path between the projection optical system and the reflection member in the support member.

7. The virtual image display device according to claim 5, wherein the dimming member is peelably affixed to a base of the reflection member.

8. The virtual image display device according to claim 5, wherein the dimming member is formed of an environment-conscious material.

9. The virtual image display device according to claim 8, wherein the environment-conscious material of the dimming member is amorphous polylactic acid.

10. The virtual image display device according to claim 5, wherein the dimming member has a thickness of 0.2 mm or less.

11. The virtual image display device according to claim 5, wherein the dimming member is clouded by a heating unit after an elapse of a lifetime of the image forming unit.

12. The virtual image display device according to claim 5, wherein the dimming member is deformed by a heating unit after an elapse of a lifetime of the image forming unit.

13. The virtual image display device according to claim 11, wherein the heating unit includes a heating element coupled to the dimming member, the heating unit causing a current to flow through the heating element, thereby heating the heating element.

14. The virtual image display device according to claim 11, wherein the heating unit is an external device and directly heats the dimming member or irradiates the dimming member with light.

15. The virtual image display device according to claim 5, further comprising:
a life count unit configured to add up an operation time of the image forming unit; and
a life determination unit configured to determine whether the operation time added up by the life count unit exceeds a lifetime predetermined.

16. The virtual image display device according to claim 11, wherein the lifetime is a time required for a luminance of an image formed by the image forming unit to reduce by half.

17. The virtual image display device according to claim 16, further comprising a sensor configured to detect a wearer wearing the virtual image display device, wherein
the image forming unit operates when the sensor detects the wearer wearing the virtual image display device.

18. A virtual image display device comprising:
an image forming unit;
a projection optical system on which image light formed by the image forming unit is incident;
a reflection member configured to reflect the image light emitted from the projection optical system and project a virtual image; and
a dimming member disposed on an optical path between the image forming unit and the virtual image, the dimming member having optical transparency and being configured to transition to a dimming state of dimming the image light under an influence of an external action, wherein
the dimming member is formed of an environment-conscious material.
